(19) United States
(12) Patent Application Publication
(10) Pub. No.: US 2024/0083323 A1
(43) Pub. Date: Mar. 14, 2024

(54) TRUCK BED PLATFORM

(71) Applicant: Diluvian, Inc., Seattle, WA (US)

(72) Inventors: Zachary Miller, Portland, OR (US); Nick DeWitt, Portland, OR (US); Todd Scott, Gladstone, OR (US); Marcos Rodriguez, Portland, OR (US); Griffin Carey, Portland, OR (US); Michael Hayes, Lake Oswego, OR (US)

(21) Appl. No.: 18/243,529

(22) Filed: Sep. 7, 2023

Related U.S. Application Data
(60) Provisional application No. 63/405,222, filed on Sep. 9, 2022.

(51) Int. Cl. B60N 3/00

(52) U.S. Cl. CPC B60N 3/008

(57) ABSTRACT

A truck bed camping and storage platform is provided. The platform is capable of being installed and removed from the rear (tailgate) of the pickup truck without the need to enter the truck bed. The platform is capable of providing cargo storage space between the platform support legs below, and a surface to sleep on above that is not constrained by the wheel wells in the truck bed. There may also be small side compartments for storage outside the legs of the baseframe of the platform and in front of and/or behind one or more of the wheel wells of the truck. The platform has the capability to be disassembled when not in use for easier storage and transportation.

### SUMMARY

Multiple solutions to camping in a pickup truck are available, including roof top tents, pop up or full campers, and travel trailers. Camping and storage platforms for the truck bed also exist but require a several hour installation process that necessitates drilling into the truck bed liner and/or frame and are therefore not easily removed if the truck bed is needed for other uses.

For those that wish to camp in their truck bed, a platform that rests above the truck bed wheel wells to maximize sleeping room, provides space for storing cargo below, and includes a soft topping to provide comfort when crawling or moving on the platform may be desirable.

It is expected that this platform will be paired with a camper shell or truck canopy to provide protection against the elements and create an enclosed camping space.

A lightweight platform that can be installed and removed in minutes without entering the truck bed and that can be easily stored may be desirable for campers who wish to use their truck for other activities.

Various features and advantages of the disclosure will be set forth in part in the following description, or may be obvious from the description, or may be learned from practice of the invention. The present application involves a platform that is installable and removable from the rear (tailgate) of the truck bed without the need to enter the bed and without the need to drill, bolt, or screw into the truck bed or frame. One aspect of one exemplary embodiment includes a camping and storage platform that is used for storing luggage below the platform, and sleeping on top. There may also be small side compartments for storage outside the legs of the baseframe of the platform and in front of and/or behind one or more of the wheel wells of the truck.

Another aspect of a further exemplary embodiment is found in a camping and storage platform as discussed herein that can be installed from the tailgate end of the truck without entering the truck bed.

Another aspect of a further exemplary embodiment is found in a camping and storage platform as immediately discussed that has panels that run the length of the truck bed.

Another aspect of a further exemplary embodiment is found in a camping and storage platform as immediately discussed that has a panel attachment system that secures the panels when placed into the truck bed.

These and other features, aspects and advantages of the present disclosure will become better understood with reference to the following description and appended claims. The accompanying drawings, which are incorporated in and constitute part of this specification, illustrate embodiments of the disclosure and, together with the description, serve to explain the principles of the disclosure.

### BRIEF DESCRIPTION OF THE DRAWINGS

A full and enabling disclosure of the present disclosure, including the best mode thereof, directed to one of ordinary skill in the art, is set forth more particularly in the remainder of the specification, which makes reference to the appended FIGS. in which:

FIG. 1 is a perspective view of a camping and storage platform fully assembled.

FIG. 2 is an exploded perspective view of the platform.

FIG. 3 is a front elevation view (as viewed from the tailgate of the truck) of the camping and storage platform of FIG. 1.

FIG. 4 is a rear elevation view (as viewed from the front of the truck bed where it meets the cab).

FIG. 5 is a top planar view of a camping and storage platform.

FIG. 6 is a side elevation view of the assembled platform.

FIG. 7 is a perspective view of the assembled baseframe (base platform) with legs.

FIG. 8 is a perspective view of the installation process, where the Top Left and Right Platforms are slid onto the baseframe.

FIG. 9 is a perspective view of the installation process, where the Top Middle Platform is slid between the Top Left and Top Right Platforms using the Left and Right Side Channel Guide Keys.

FIG. 10 is a detailed view of the Top Middle Platform sliding between Top Left and Top Right Platforms using the Left and Right Side Channel Guide Keys.

FIGS. 11A, 11B and 11C are respective cross-sectional elevation side views of the cabside panel attachment system, showing how the panels lock into place as the top panels are 1) Placed on top the baseframe 2) Slid along the baseframe, 3) And slid to the back (truck cab side) edge of the baseframe to lock the top platform down to the baseframe.

FIG. 12 is a detailed perspective view of the underside of the panel attachment system.

Repeated use of reference characters in the present specification and drawings is intended to represent the same or analogous features or elements of the disclosure.

### DETAILED DESCRIPTION OF REPRESENTATIVE EMBODIMENTS

Reference will now be made in detail to embodiments of the disclosure, one or more examples of which are illustrated in the drawings. Each example is provided by way of explanation of the invention, and not meant as a limitation of the invention.

It is to be understood that the ranges mentioned herein include all ranges located within the prescribed range. As such, all ranges mentioned herein include all sub-ranges included in the mentioned ranges. For instance, a range from 100-200 also includes ranges from 110-150, 170-190, and 153-162. Further, all limits mentioned herein include all other limits included in the mentioned limits. For instance, a limit of up to 7 also includes a limit of up to 5, up to 3, and up to 4.5.

Number Legend for FIGS.:

| | |
|---|---|
| 1 | Left Leg |
| 2 | Right Leg |
| 3 | Tailgate Section of Baseframe |
| 4 | Mid Section of Baseframe |
| 5 | Cab Section of Baseframe |
| 6 | Baseframe Cleat |
| 7 | Top Right Side Platform Panel |
| 8 | Top Left Side Platform Panel |
| 9 | Top Middle Platform panel |
| 10 | Right Side Channel for Platform Alignment |
| 11 | Left Side Channel for Platform Alignment |
| 12 | Front Face Connector Logo Plate |
| 13 | Height Adjustable Feet |
| 14 | Left Side Gasket |
| 15 | Right Side Gasket |
| 16 | Left Side Channel Guide Key |
| 17 | Right Side Channel Guide Key |
| 18 | Top Middle Platform Panel Cleat |
| 19 | Top Left Side Platform Panel Cleat |
| 20 | Top Right Side Platform Panel Cleat |
| 21 | Plastic Anti-wear Strips |
| 22 | Complete Platform Assembled |
| 23 | Base Frame Assembled |
| 24 | Pull Handle |

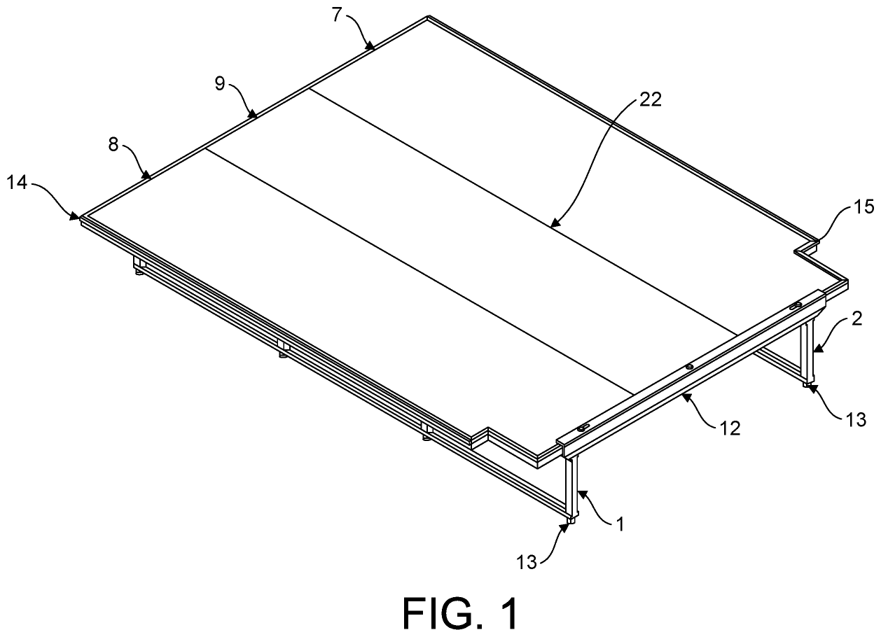

FIG. 1 is a perspective view of a camping and storage platform fully assembled. As shown in FIG. 1, the present disclosure involves a camping and storage platform 22. In accordance with one exemplary embodiment, the platform is installable and removable from the rear (tailgate) of the truck bed without the need to enter the bed and without the need to drill, bolt, or screw into the truck bed or frame and can be used for storing cargo and sleeping.

The platform 22 (which may be a platform panel comprised of multiple individual platform panels) is constructed to be lightweight so that the pieces are easily carried for installation, removal and storage. The platform 22 is constructed to have a soft surface, such as a pad, carpet, foam or other padding material affixed to the top surface of the platform 22, so that climbing and crawling on the platform surface is comfortable.

One exemplary embodiment of the platform 22 is shown in FIG. 1. In FIG. 1, the platform is shown as it will appear when assembled and installed inside a truck bed.

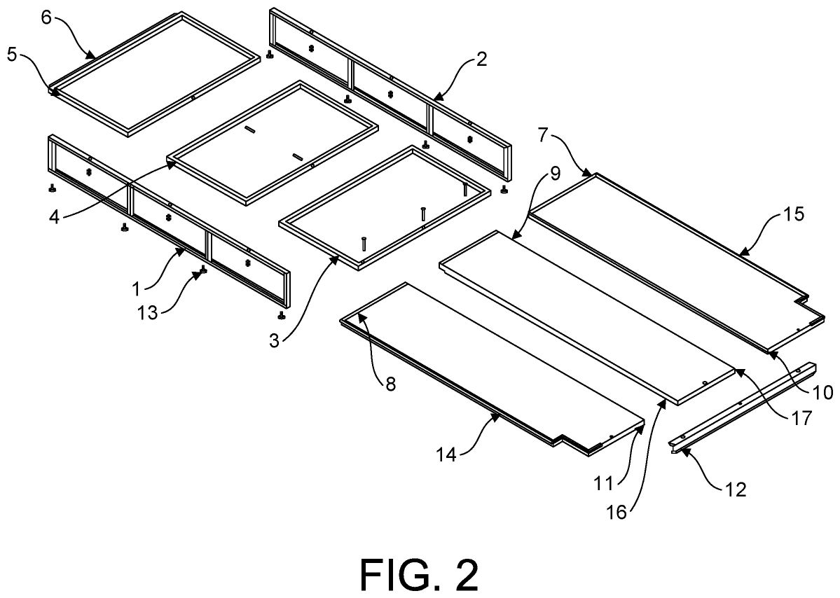

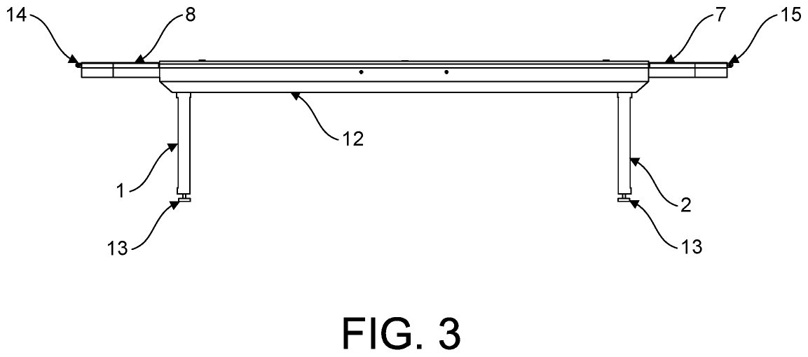

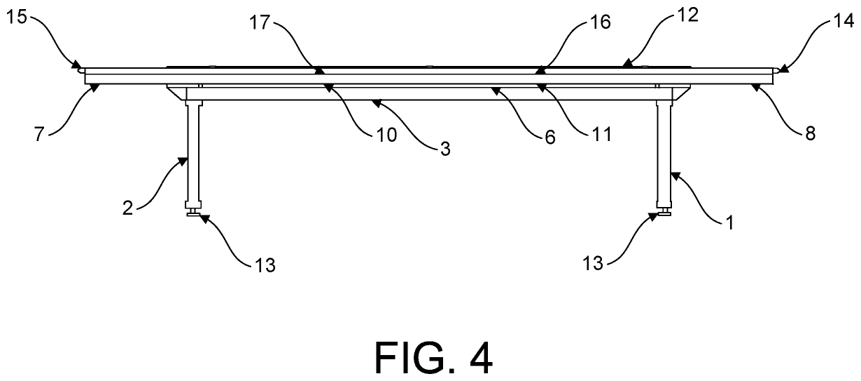

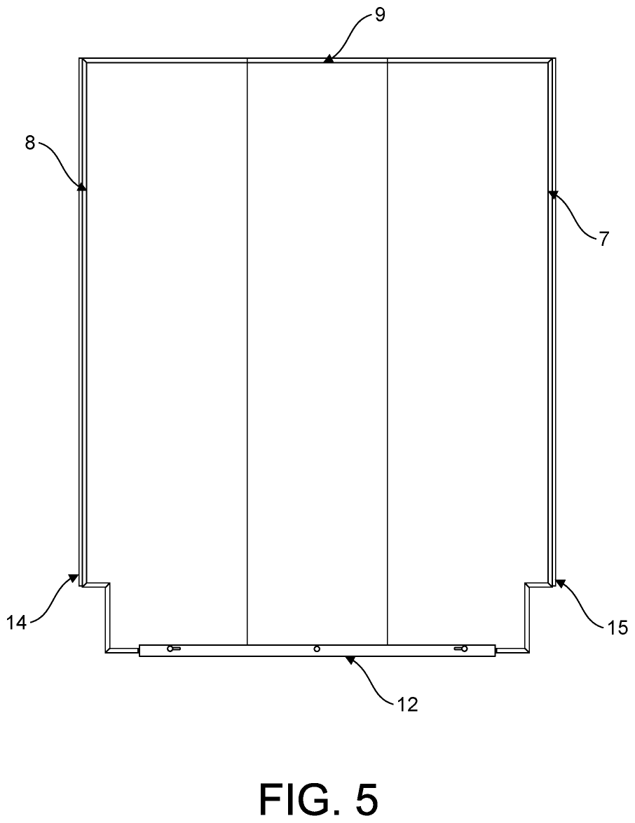

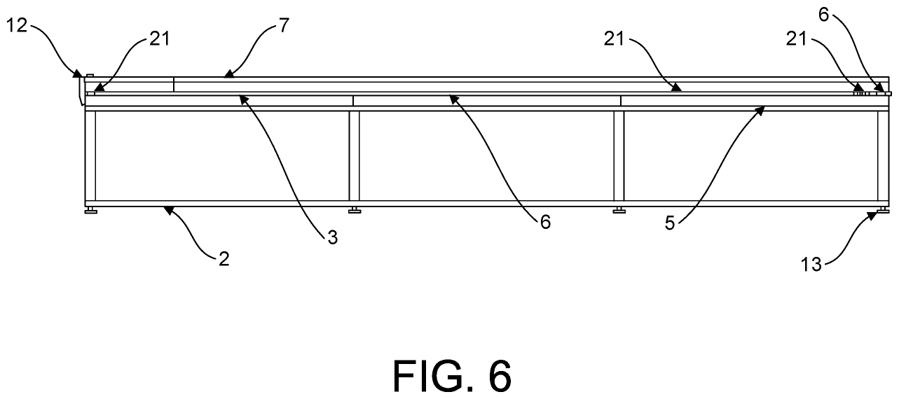

FIGS. 2 through 6 are various views of the platform of FIG. 1 to show the components and construction. FIG. 2 is an exploded perspective view of the platform 22. FIG. 3 is a front elevation view (as viewed from the tailgate of the truck) of the camping and storage platform 22 of FIG. 1. FIG. 4 is a rear elevation view of the platform 22 (as viewed from the front of the truck bed where it meets the cab). FIG. 5 is a top planar view of a camping and storage platform 22. FIG. 6 is a side elevation view of the assembled platform 22.

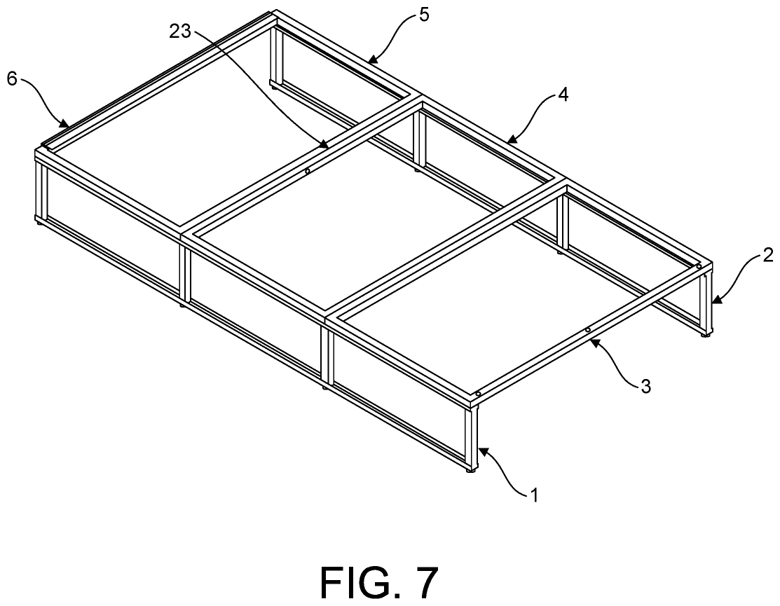

FIG. 7 is a perspective view of the assembled baseframe (base platform) with legs. The baseframe 23 of the platform 22 is composed of a left leg 1 and right leg 2, constructed of welded 1/16″ wall aluminum square tubing and ⅛″ wall aluminum channel. However, other sizes, dimensions and materials may be used in various embodiments. The legs are connected by the tailgate section of the baseframe 3 (also comprised of 1″ aluminum square tubing), the midsection of the baseframe 4, and the cab section of the baseframe 5. These sections 3 through 5 can be constructed of welded 1″ aluminum square tubing, or can be individual lengths of tubing which are connected to and spanning between legs 1 and 2.

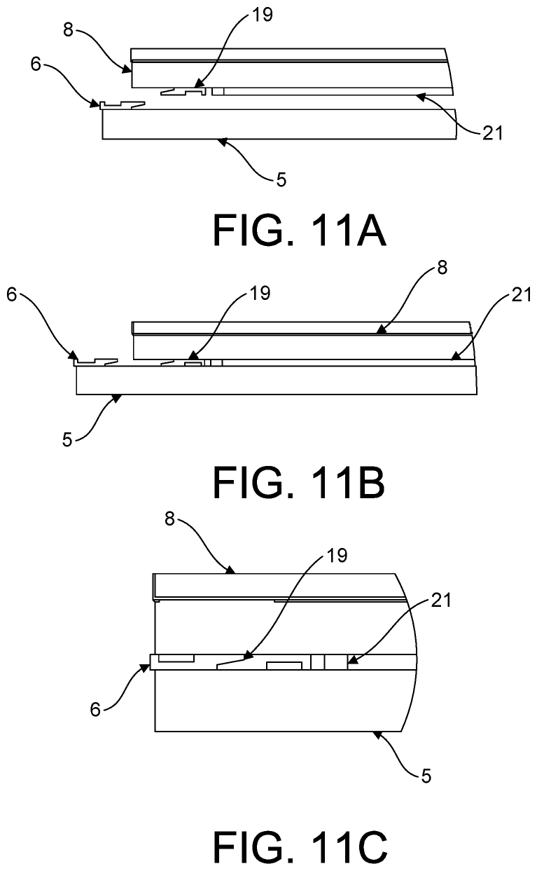

FIGS. 11A through 11C are respective cross-sectional side views of the truck cabside panel attachment system, showing how the top panels lock into place as the top panels are 1) Placed on top the baseframe 23 2) Slid along the baseframe 23, 3) And slid to the back (truck cab side) edge of the baseframe 23 to lock the top platform 22 down to the baseframe 23. The baseframe 23 also has an aluminum cleat 6 which is part of the panel attachment system and allows the panel ends nearest the truck cab to securely connect without one entering the bed. A top right side platform panel 7, top left side platform panel 8, and top middle platform panel 9 are secured on top of the baseframe 23 (shown in FIG. 7) to provide a surface for sleeping. The left 7 and right 8 panels each have a left side gasket 14 and right side gasket 15 (made, for example, of Ethylene Propylene Diene Monomer (EPDM) sponge rubber), respectively, attached to the edge of the respective panel that adjoins the truck bed with thin 3M™ VHB™ adhesive tape. The gaskets fill in spaces caused by bed contours and create a snug fit for the platform within the truck bed.

Referring again to FIGS. 1 through 6, the top right side platform panel 7, top left side platform panel 8, and top middle platform panel 9 are constructed of welded, primarily 1/16″ to ⅛″ wall aluminum square tubing. However, other sizes, dimensions and materials may be used in various embodiments. A piece of tubing between 0.75″×3″ to 1″×3″ is used on the truck cab side of the platforms to help accommodate the cab facing attachment cleats 18, 19, and 20. Depending on the material choice for this back edge, plastic anti-wear strips 21 from 1/32″ to ¾″ thick may be used to reduce wear on the baseframe 23. However, other sizes, dimensions and materials may be used in various embodiments. This plastic may be an ultra-high molecular weight polyethylene (UHMW) material or ultraviolet (UV) resistant High Density Poly Ethylene (HDPE) material. Also shown FIGS. 3 and 4 are height adjustable feet 13 operably attached to left leg 1 and right leg 2 (e.g., two height adjustable feet 13 may be attached to each leg to contact the truck bed and provide support for and adjust the height of the baseframe 23).

The framing of these top panels (top right side platform panel 7, top left side platform panel 8, and top middle platform panel 9) may also be accomplished using ⅛ ″ wall channel in place of square tubing on the short edges, with three sections of square tubing still being used (as is the case in the welded frame) at the full length of the panels to support a 1/16″ aluminum top sheet. However, other sizes, dimensions and materials may be used in various embodiments. A carpet or other padding may be applied to this top sheet using a high strength VHB tape or adhesive, for example. The aluminum top panel can be attached to the square tubing frame of the panels via welds or rivets. However, other fastening means may be used in various embodiments. The top right 7 and left 8 panels each have a right 10 and left 11 side channel alignment, respectively, that connects with the left side channel guide key 16 and right side channel guide key 17 of the top middle platform panel 9. The channel guide keys are made of approximate 0.75″×0.375″ UV resistant HPDE, and are riveted to each side of the center top panel 9. The channel alignments are constructed with a 1″ overall width Aluminum Channel with ½″ legs and ⅛″ wall thickness to create a snug slip fit for the channel guide keys 16 and 17. However, other sizes, dimensions and materials may be used in various embodiments.

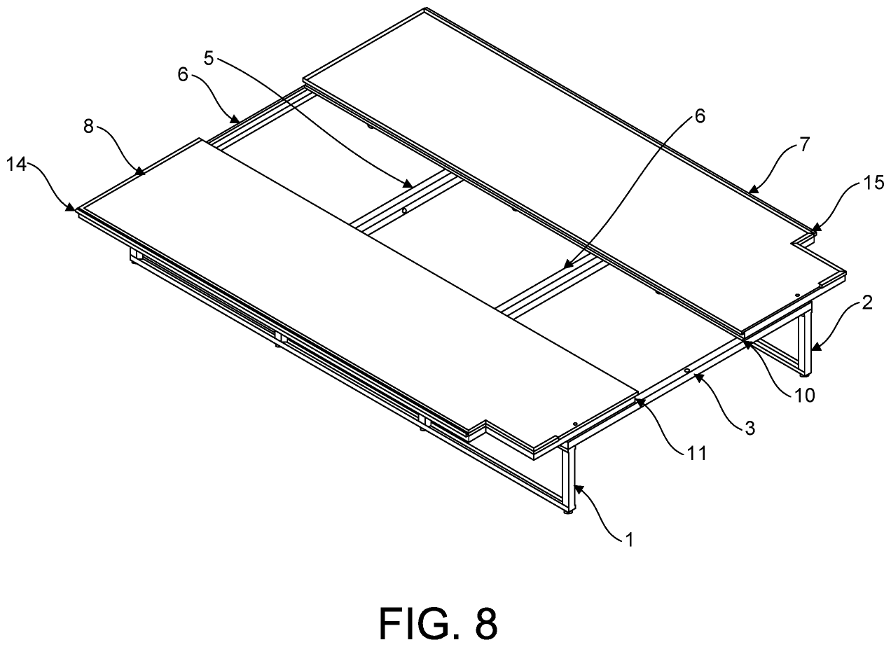

FIGS. 8-12 are views of the installation process and detailed views of the cab side cleat attachment mechanism.

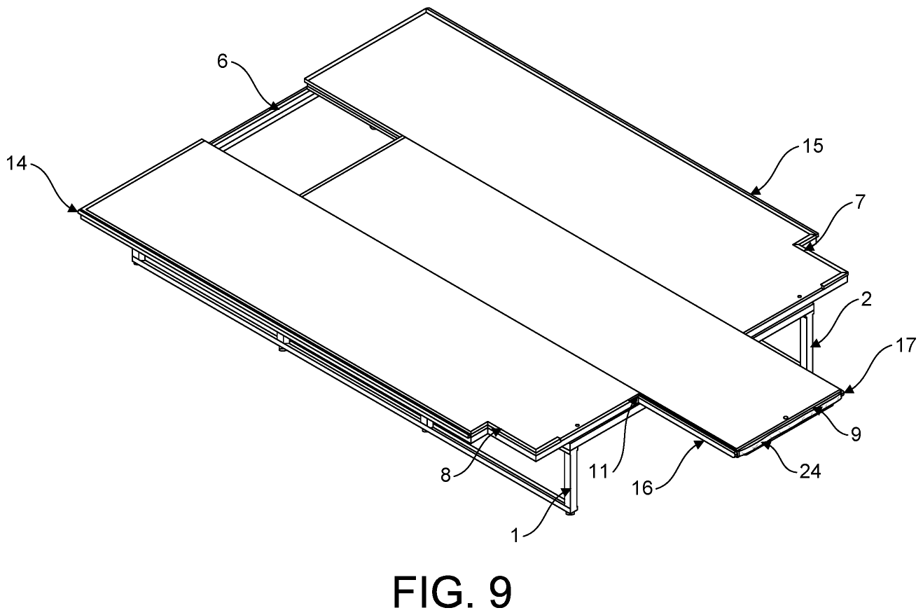

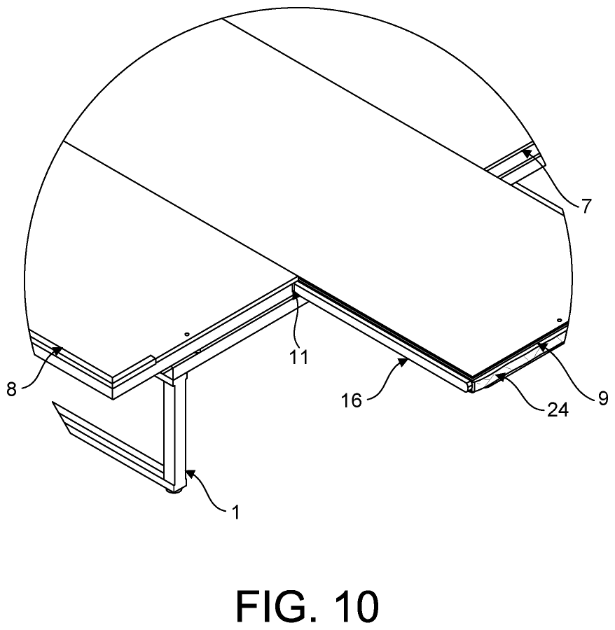

FIG. 8 is a perspective view of the installation process, where the top left side platform panel 8 and top right side platform panel 7 are slid onto the baseframe 23. FIG. 9 is a perspective view of the installation process, where the top middle platform panel 9 is slid between the top left side platform panel 8 and top left side platform panel 7 using the left side channel guide key 16 and right side channel guide key 17. FIG. 10 is a detailed view of the top middle platform panel 9 sliding between top left side platform panel 8 and top right side platform panel 7 using the left side channel guide key 16 and right side channel guide key 17. FIGS. 11A through 11C are respective cross-sectional side views of the cabside panel attachment system, showing how the top panels (top left side platform panel in the example shown in FIGS. 11A through 11C) lock into place as the top panels are 1) Placed on top the baseframe 23 2) Slid along the baseframe 23, 3) And slid to the back (truck cab side) edge of the baseframe 23 to lock the top platform 22 down to the baseframe 23.

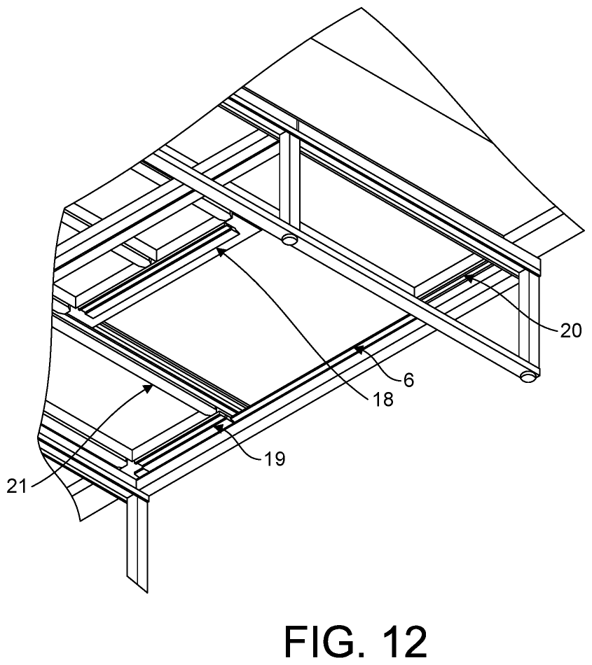

FIG. 12 is a detailed perspective view of the underside of the panel attachment system.

To install the platform, the assembled baseframe 23 is placed in the truck bed (not shown). The right side platform panel 7 and left side platform panel 8 are placed on top of the baseframe 23 and moved to their respective sides of the truck bed. The middle top platform panel 9 is then slid between the right side platform panel 7 and left side platform panel 8 using channel 10 and channel 11, respectively, and corresponding right side guide key 17 and corresponding left side guide key 16, respectively.

As shown in FIGS. 11A through 11C and FIG. 12, the cab facing edge of the top right side platform panel 7, top left side platform panel 8, and top middle platform panel 9 each has a respective cleat indicated by top right side platform panel cleat 20, top left side platform panel cleat 19, and top middle platform panel cleat 18, respectively, that attaches to a corresponding baseframe cleat 6 on the baseframe 23. These aluminum cleats are a matching pair to cleat 6, and are mounted upside down to the underside of the top right side platform panel 7, top left side platform panel 8, and top middle platform panel 9 to allow the respective cleats on top right side platform panel 7, top left side platform panel 8, and top middle platform panel 9 to all slide into contact on the underside of cleat 6 and securely clamp top right side platform panel 7, top left side platform panel 8, and top middle platform panel 9 to the baseframe 23. FIG. 11 illustrates how top left side platform panel cleat 19 slides into contact with baseframe cleat 6. FIG. 11A shows top left side platform panel 8 having cleat 19 above the cab section of baseframe 5 about to be placed on cab section of baseframe 5. FIG. 11B shows top left side platform panel 8 having cleat 19 on the cab section of baseframe 5, but not yet slid into place. FIG. 11C shows top left side platform panel 8 having cleat 19 slid into place, with cleat 19 in contact with cleat on the underside of cleat 6.

As the top right side platform panel 7, top left side platform panel 8, and top middle platform panel 9 meet the back (cab end) of the truck bed (not shown), the panel attachment system secures them to the baseframe 23. The installation of the top middle platform panel 9 also secures the platform 22 to the bed edges by pushing the top left side platform panel 8 and top right side platform panel 7 out, expanding the top platform 22 to fill the width of the truck bed, and creating a more stable and secure structure by restricting side to side movement.

After the panels of the platform 22 are aligned, the front face connector logo plate 12, as shown in FIGS. 3 and 5, is placed onto the front (tailgate facing) edge of the platform and secured by three bolts, each passing through the top panels and bolting to the baseframe 23. In some embodiments, the front face connector logo plate 12 may include a logo or other design (not shown) associated with the manufacturer or seller of the platform 22.

To uninstall the platform 22, the procedure above is performed in reverse. The face connector logo plate 12 also can function as a storage system. The platforms are stacked on top of each other, nylon straps are run through the slots on the connector logo plate 12 and secure the platform and may be carried as a unit using the connector plate. In some example embodiments, a pull handle 24, as shown in FIGS. 9 and 10, may also be attached to the front (tailgate facing) edge of the platform 22, such as on the front (tailgate facing) edge of the top middle platform panel 9. For example, the pull handle 24 may be used to conveniently pull out the top middle platform panel 9 to uninstall the platform 22. The pull handle may be made of cloth, nylon, plastic, metal or other durable material. In such embodiments, the front face connector logo plate 12 as shown in FIGS. 3 and 5 may be placed onto the front (tailgate facing) edge of the platform over the pull handle 24. In an example embodiment, the pull handle may be attached on an edge of at least one of the plurality of platform panels configured to face a tailgate end of the truck when installed in the truck and assist in sliding out the at least one of the plurality of platform panels after the at least one of the plurality of platform panels is installed in the truck.

Where a phrase similar to “at least one of A, B, or C,” “at least one of A, B, and C,” “one or more A, B, or C,” or “one or more of A, B, and C” is used, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

As used herein, the term “or” may be construed in either an inclusive or exclusive sense. Moreover, plural instances may be provided for operations or structures described herein as a single instance. Additionally, particular structure and operations are illustrated in a context of specific illustrative configurations. Others are envisioned and may fall within a scope of various embodiments of the present disclosure. In general, structures and functionality presented separately in the example configurations may be implemented as a combined structure in view of the disclosure. Similarly, structures and functionality presented as a single item may be implemented as separate items. These and other variations, modifications, additions, and improvements fall within a scope of embodiments of the present disclosure as represented by the appended claims. The specification and drawings are, accordingly, to be regarded in an illustrative rather than a restrictive sense. Other sizes, dimensions and materials of components described herein may be used in various different embodiments.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A platform for a truck bed of a truck, the platform comprising:
a baseframe configured to fit in the truck bed between two wheel wells of the truck; and
a modular platform panel resting on top of the base frame and spanning over the two wheel wells, the modular platform panel comprised of a plurality of platform panels, wherein the platform panel has a width spanning substantially an interior width of the truck bed above the two wheel wells.

2. The platform of claim 1 wherein:
at least one panel of the plurality of platform panels is slidably connected to another panel of the plurality of platform panels via a channel along a length of the other panel.

3. The platform of claim 1 further comprising:
A cleat on a truck cab end of the baseframe into which a corresponding cleat on the top panel slides when the top panel is slid onto the baseframe, wherein the top panel is secured by the cleat when the top panel is slid onto the baseframe and prevented from sliding any further toward the cab while also being allowed slide back off the baseframe toward a tailgate end of the truck when being uninstalled from the truck.

4. The platform of claim 1 further comprising:
a plate connected to an edge of the platform panel facing a tailgate end of the truck that secures the plurality of platform panels.

5. The platform of claim 4 wherein the plate is connected to the edge of the platform panel by a plurality of fasteners.

6. The platform of claim 5 wherein the plurality of fasteners is a plurality of bolts, and the plate is connected to the edge of the platform panel by a plurality of bolts, wherein each bolt of the plurality of bolts passes through a respective platform panel of the plurality of platform panels and into the baseframe.

7. The platform of claim 5 wherein the plate includes slots into which straps are inserted to hold the plurality of platform panels when stacked on each other and using the plate as a handle to carry the plurality of platform panels.

8. The platform of claim 1 wherein the platform is manually installable in the truck bed without one setting foot in the truck bed.

9. The platform of claim 1 wherein the plurality of platform panels consists of a middle platform panel, a left side platform panel slidably connected to the middle platform panel via a channel along a length of left edge of the middle platform panel and a right side platform panel slidably connected to the middle platform panel via a channel along a length of a right edge of the middle platform panel.

10. The platform of claim 1 wherein the baseframe is comprised of aluminum square tubing.

11. The platform of claim 1 further comprising:
padding affixed to a top surface of the platform panel

12. The platform of claim 1 further comprising:
a gasket along at least lengthwise edges of the platform panel configured to fill in spaces between the truck bed and the platform panel caused by truck bed contours and to create a snug fit for the platform panel within the truck bed.

13. A method for installing a platform for a truck bed of a truck including:
installing a baseframe in the trick that is configured to fit in the truck bed between two wheel wells of the truck; and
installing a modular platform panel to rest on top of the base frame and spanning over the two wheel wells, the installing the modular platform including installing a plurality of platform panels, wherein the modular platform panel has a width spanning substantially an interior width of the truck bed above the two wheel wells.

14. A kit for a platform for a truck bed of a truck, the kit comprising:
a baseframe configured to fit in the truck bed between two wheel wells of the truck; and
a modular platform panel configured to rest on top of the base frame and span over the two wheel wells, the modular platform panel comprised of a plurality of platform panels, wherein the modular platform panel has a width spanning substantially an interior width of the truck bed above the two wheel wells.

15. A platform for a truck bed of a truck, the platform comprising:
a baseframe configured to fit in the truck bed between two wheel wells of the truck; and
a plurality of platform panels that, when assembled, comprise a modular platform panel configured to be placed on top of the base frame, wherein, when assembled, the platform panel has a width spanning substantially an interior width of the truck bed above the two wheel wells.
